(19) United States
(12) Patent Application Publication
(10) Pub. No.: US 2011/0194741 A1
(43) Pub. Date: Aug. 11, 2011

(54) BRAIN VENTRICLE ANALYSIS

(75) Inventors: Ahmet Ekin, Eindhoven (NL); Jingnan Wang, Eindhoven (NL)

(73) Assignee: KONONKLIJKE PHILIPS ELECTRONICS N.V., Eindhoven (NL)

(21) Appl. No.: 13/122,976

(22) PCT Filed: Sep. 30, 2009
(86) PCT No.: PCT/IB2009/054279

§ 371 Date: Apr. 7, 2011

(30) Foreign Application Priority Data
Oct. 7, 2008 (EP) 08166005.2

(51) Int. Cl. G06K 9/00; G06F 19/00

(52) U.S. Cl. 382/128; 702/19

(57) ABSTRACT

A system for analyzing a brain ventricle (8) is described. The system comprises an edge detector (52) for identifying an edge point (17) on an edge of the brain ventricle. Also, a length measurer (53) is provided for establishing a length measure of a path (10) starting from a central point (5) of the brain ventricle and terminating at the edge point (17). The edge detector (52) is arranged for detecting an edge point at an end of a lobe of the brain ventricle, the length measure corresponding to an extent of the lobe.

### FIELD OF THE INVENTION

The invention relates to analyzing a brain ventricle.

### BACKGROUND OF THE INVENTION

Alzheimer's disease (AD) is the most common form of dementia and accounts for 50 to 70 percent of cases. Alzheimer's disease afflicts an estimated 24 million people worldwide. Since age is the primary risk factor, the demographic trend of an aging population will double these numbers by 2025. Although there is currently no drug that can stop or prevent the disease, there are various symptomatic drugs that relieve the symptoms and, in some cases, slow down the progress. Most of these drugs are effective only in the early or mid-stages of the disease, making early detection desirable. Currently, the primary tests for diagnosis of Alzheimer's disease are cognitive tests. Depending on the design, these tests can measure various cognitive functions, such as memory, attention, orientation, language, and learning. The main appeal of these tests, such as mini-mental state examination (MMSE), is their ease of administration, but the results can be subjective and affected by a patient's mental and physical state at the time of the test. In the diagnosis of Alzheimer's disease, although cognitive test scores are powerful, medical imaging is also useful. For example, imaging may be used for eliminating possible other causes, such as a tumor, explaining a low cognitive score. Imaging techniques may be used in the process of assessing which particular form of dementia a patient has (Alzheimer's disease, or another form of dementia, such as vascular or fronto-temporal). Moreover, some patients, especially of higher education and intelligence, are able to hide cognitive deficits in the tests for a long time. In such a case, image-based analysis can detect Alzheimer's disease earlier by quantifying the structural brain changes. A review of computer-assisted imaging techniques for assessing brain structure in relation to brain disease is given in “Computer-assisted imaging to assess brain structure in healthy and diseased brains”, by J. Ashburner et al., The Lancet Neurology Vol. 2, February 2003, pp. 79-88.

### SUMMARY OF THE INVENTION

It would be advantageous to have an improved system for analyzing brain structure. To better address this concern, in a first aspect of the invention a system for analyzing a brain ventricle is presented that comprises

an edge detector for identifying an edge point on an edge of the brain ventricle; and

a length measurer for establishing a length measure of a path comprising a central point of the brain ventricle and terminating at the edge point.

The length obtained by means of this system is correlated with brain disease, such as Alzheimer's disease. Thus, the system provides a reproducible, automatic measurement which can be used as a numeric value which a physician can take into account in finding a diagnosis of a patient. Alternatively, this value can be used as the input to a computerized decision support system, which can find a diagnosis based on this value and optionally on other input data.

The path may start at the central point. In this case, a distance from the central point to the edge point along the path is established.

The edge detector may be arranged for detecting an edge point at an end of a lobe of the brain ventricle, the length measure corresponding to an extent of the lobe. The extent of a lobe of a brain ventricle was found to correlate with brain disease, in particular Alzheimer's disease. The use of a central point of the lateral ventricle and an edge point near an end of the posterior right lobe of the lateral ventricle, resulted in a high correlation with Alzheimer's disease.

Also, a width of a third ventricle of a brain visible in a medical image was shown to have good correlation with brain disease, such as Alzheimer's disease. Such a width may be established by selecting two edge points of the brain ventricle which are connected by a line intersecting the center point, such that a distance between the two edge points is substantially minimal, the length measurer being arranged for establishing the substantially minimal distance.

The edge detector may be arranged for identifying a plurality of edge points on the edge of the brain ventricle, and the length measurer may be arranged for establishing the length from the central point to each of the plurality of edge points, to obtain a plurality of lengths. Such a plurality of lengths starting from the same central point provides more information which may be processed by a decision support system, for example.

The plurality of lengths may be used by a statistics module for computing a statistical quantity of the plurality of lengths. Such a statistical quantity may be used in the process of diagnosis of a brain disease. For example, the average of the lengths of a plurality of lengths extending from the central point in different directions distributed fully around the central point was found to have a high correlation with Alzheimer's disease.

The system may comprise a central point detector for identifying a central point of at least part of the brain ventricle. However, this central point does not have to be explicitly computed in all embodiments.

The system may further comprise means for identifying a region of the image, a boundary of the region being based on a first central point of the brain ventricle, and means for identifying a second part of the brain ventricle comprising an intersection of the first part of the brain ventricle with the region, the center point detector further being arranged for identifying a second central point of the second part of the brain ventricle. This provides a robust way of identifying points of the ventricle. The resulting process may be repeated, by identifying a further region whose boundary is based on the second central point and identifying a central point of the part of the ventricle in the further region. The length measure may be computed as a length of a path along the central points thus identified. This provides a robust and accurate way of finding the length of a lobe of the ventricle. Also, the end of the ventricle can be estimated in this way, by iterating the process of identifying a central point and identifying a region, whose boundary is based on the central point, a few times. The boundary of the region may, for example, comprise the first central point.

The medical image may comprise a 2D cross section of a 3D medical image dataset. 2D images allow for relatively efficient computations.

A medical workstation may be provided comprising the system set forth and an output for generating a human readable representation of the length measure and a graphical indication of the path in the medical image. This allows a clinician to review the relevant quantities.

A medical imaging apparatus may be provided for acquiring a medical image, the medical imaging apparatus comprising the system set forth. This allows the computations to be performed immediately after, and at the location of, the image acquisition.

A method of analyzing a brain ventricle represented in a medical image dataset comprises

identifying an edge point on an edge of the brain ventricle; and

establishing a length measure of a path through the ventricle, the path terminating at the edge point and comprising a central point of the brain ventricle.

A computer program product may be provided comprising computer instructions for causing a processor system to perform the method set forth.

It will be appreciated by those skilled in the art that two or more of the above-mentioned embodiments, implementations, and/or aspects of the invention may be combined in any way deemed useful.

Modifications and variations of the image acquisition apparatus, of the workstation, of the system, and/or of the computer program product, which correspond to the described modifications and variations of the system, can be carried out by a person skilled in the art on the basis of the present description.

A person skilled in the art will appreciate that the method may be applied to multidimensional image data, e.g., to 2-dimensional (2-D), 3-dimensional (3-D) or 4-dimensional (4-D) images, acquired by various acquisition modalities such as, but not limited to, standard X-ray Imaging, Computed Tomography (CT), Magnetic Resonance Imaging (MRI), Ultrasound (US), Positron Emission Tomography (PET), Single Photon Emission Computed Tomography (SPECT), and Nuclear Medicine (NM).

### BRIEF DESCRIPTION OF THE DRAWINGS

These and other aspects of the invention will be further elucidated and described with reference to the drawing, in which

FIG. 1A shows a cross sectional slice of a brain MR image of a healthy control;

FIG. 1B shows a cross sectional slice of a brain MR image of a patient diagnosed with Alzheimer's disease;

FIG. 2 illustrates schematically several aspects of a brain ventricle;

FIG. 3 illustrates a graph representing a “Signature map descriptor”;

FIG. 4 shows a diagram of a system for analyzing a brain ventricle;

FIG. 5 illustrates schematically several aspects of a brain ventricle;

FIG. 6 shows a diagram of a method of analyzing a brain ventricle.

### DETAILED DESCRIPTION OF EMBODIMENTS

One of the symptoms of Alzheimer's disease (AD) is the loss of neurons in the brain. In many cases, the medical experts use MR (magnetic resonance) images to qualitatively measure the neuronal loss by the shrinkage (atrophy) of the structures of interest, or sometimes more easily by the enlargement of the fluid-filled structures, such as the ventricles. For quantitative analysis, volume is used. Volume, or area in 2D, is a rough measure which does not provide detailed shape analysis. On the other hand, medical experts are hesitant to use shape descriptors which are complex, difficult-to-reproduce, or difficult-to-understand. This is why experts may prefer to use area and volume in their diagnosis. In this text, novel and easily-extractable shape descriptors for brain ventricles are disclosed. It was found that these are better descriptors in the classification of, for example, Alzheimer's disease patients and healthy controls.

One of the structural changes occurring in the brain due to aging and Alzheimer's disease is the enlargement of ventricles. The ventricles are filled with cerebrospinal fluid, a watery solution that provides physical and nutritional support to the brain. The ventricles are enlarged at the expense of atrophy resulting from neuronal loss.

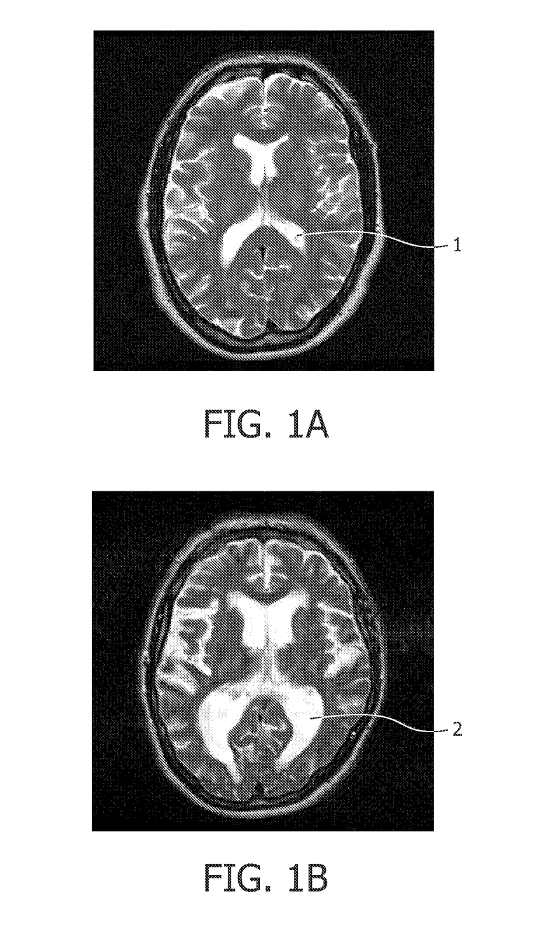

In FIG. 1, ventricles are visible as central hyper-intense regions for a healthy control and an Alzheimer's disease patient. FIG. 1A shows an axial MR T2 slice of a healthy control. FIG. 1B shows an axial MR T2 slice of a patient having Alzheimer's disease. In both Figures, the bright white areas 1 and 2 in the middle of the images are the ventricles. In clinics, the volume of ventricles may be used qualitatively or quantitatively in the diagnosis of Alzheimer's disease. However, the shape of several brain structures, including ventricles, may provide more information than the volume. Some shape descriptors for ventricle analysis make use of advanced processing techniques that are sensitive to parameter settings. This hampers their widespread clinical use. In this text, systems and methods are described for providing descriptors of ventricles that are easier to extract or easier to understand.

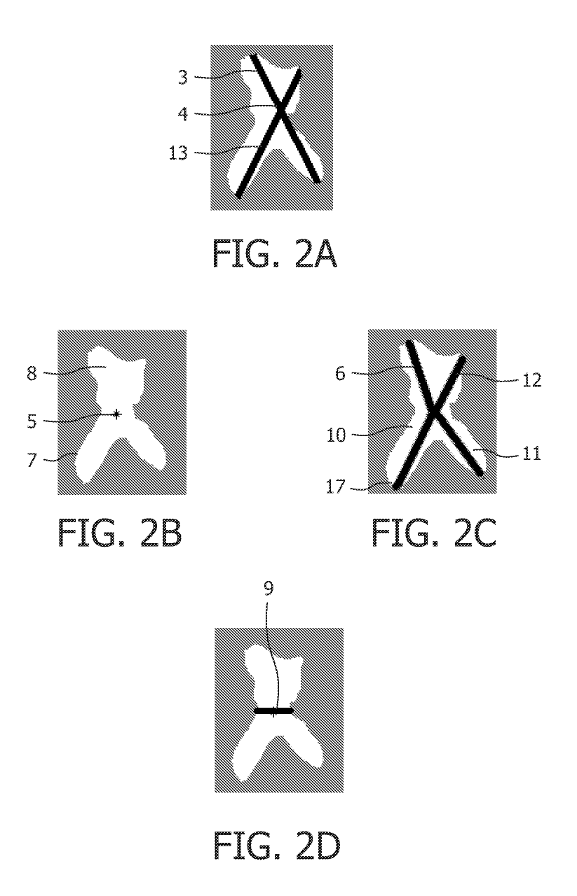

FIGS. 2A-D and 5A-E illustrate some aspects of shape descriptors. These Figures show, schematically, the same medical image a number of times with different annotations. In these Figures, like objects have been indicated with the same reference numerals. The white portion 8 represents a brain ventricle in a medical image. Although a 2D medical image is shown, in particular a cross sectional slice of an MR brain image, the methods and systems described herein may be applied to 3D images as well.

Some useful shape descriptors include:

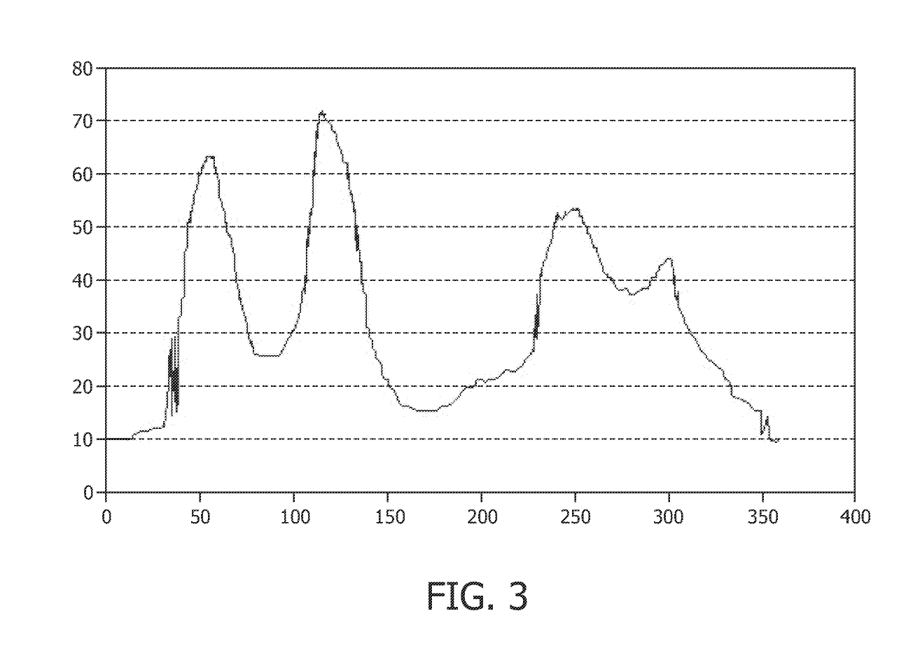

“Wing length”: Any of four distance values from a lateral ventricle's 8 central point 5 (FIG. 2B) to the four corners, or end points 17 of the four visible lobes in an MR axial slice image (anterior left, anterior right, posterior left, and posterior right). This is shown in FIG. 2C, the four distances being indicated at numerals 6, 10, 11, and 12. “Signature map descriptor”: The signature map comprises a plurality of length values, each length value corresponding to an angle. The value corresponding to an angle is a distance from a central point 5 such as the centroid of the ventricle to an edge point 7 of the ventricle 8 along a line extending from the central point 5 in a direction defined by the angle. FIG. 3 shows an example signature map. The horizontal axis shows the angle in degrees. The vertical axis shows the length value corresponding to the angle in an arbitrary unit. It can be seen that directions spanning 360 degrees have been used. A statistical value may be used as the signature map descriptor. Examples of signature map descriptors include the mean value, or the median value, of the length measurement values appearing in the signature map.

“Width/Thickness”: Indicated at 9 in FIG. 2D, the smallest thickness of the ventricle for the axial slice showing basal ganglia. Alternatively, this width/thickness may be defined as the average width of the third ventricle. Third ventricle is a known anatomical region of the human brain, located around the central point 5. This feature may be computed, for example, by computing the extent of the ventricle from the central point 5 in the right direction and from the central point 5 in the left direction, and adding the two together.

“Cross length”, indicated in FIG. 2A, may also be used: the distance from the end of one lobe to the end of an opposite lobe. One such distance is indicated at 3, another one at 13. The intersection point 4 of two such defined cross lines may be used as a central point.

These descriptors are relatively easy to extract from a medical image.

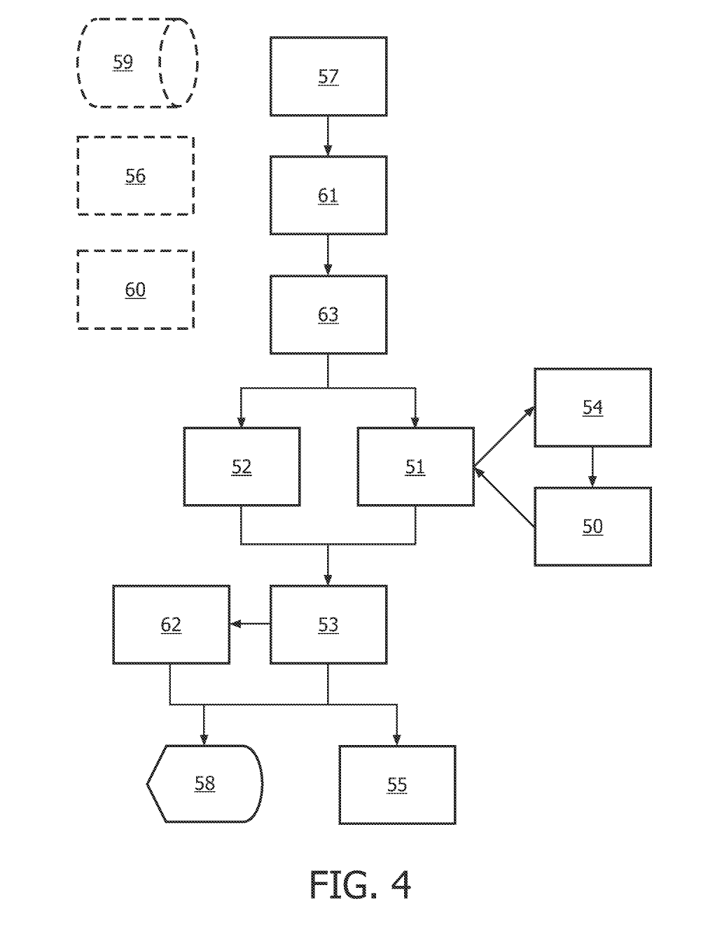

FIG. 4 shows a diagram illustrating aspects of a system for analyzing a brain ventricle. The system shown in the Figure and described hereinafter is an example only. Many of its features are optional. The system comprises a memory 59 for storing medical image data and other data, such as intermediate results and state information. The memory 59 comprises, for example, a random access memory, a read-only memory, a flash memory, a magnetic disc, and/or a database server. The system further comprises a processor system 56. The processor system 56 comprises one or more processors. The system further comprises a control unit 60 comprising computer instructions for causing the processor to perform certain tasks. The control unit 60 controls the operation of and interaction between other units, the memory, and the processor. Most of the other units to be described hereinafter may be implemented by means of a software code stored in the memory 59 or by means of an electronic circuit, for example. Other units may comprise hardware elements such as a display or a medical imaging apparatus 57.

An input 61 may be provided for receiving a medical image and storing it in the memory 59, so that the image is available to the system for analysis. The input 61 may be directly connected to a medical imaging apparatus 57. It is also possible that the input is connected to a digital communication network by means of a network connection. The images can be imported from a data server via the network, for example. The network can be a local area network, or the Internet, for example. The input 61 may also be arranged for retrieving the image data from a removable media device, such as a DVD or CD-ROM, or from a magnetic disc. The input 61 may trigger an edge detector 52 and/or a central point detector 51 to perform their tasks, as described hereinafter, via the control unit 60. This triggering may also be done by the control unit 60 in response to user input via a user interface comprising, for example, a mouse and keyboard (not shown) or in response to a request from a decision support system.

Segmentation means 63 may be provided for segmenting the brain ventricle in the image. The segmentation means 63 receives the image data from the input 61 and forwards it to the edge detector 52 and/or to the central point detector 51. Such a segmentation means may be arranged for comparing intensity levels of image elements (such as pixels or voxels) to a threshold. For example, image elements above the threshold are classified as being part of the brain ventricle. Many other segmentation methods are known to the skilled person. A suitable segmentation method is model-based segmentation. In alternative embodiments, the segmentation means 63 may be omitted, for example the input 61 may be arranged for receiving segmented data, or the edge detector 52 and/or the central point detector 51 may be arranged for working directly on the non-segmented data.

An edge detector 52 may be provided for identifying an edge point on an edge of the brain ventricle. The edge detector 52 may employ known methods for identifying the edge point. After having segmented the brain ventricle, in view of this description, the skilled person knows how to identify one or more points on the edge of the brain ventricle. Other methods of identifying an edge point, i.e. other than segmentation, are also known and can be applied in the edge detector 52. For example, edges can be detected by means of gradient estimation. The edge of the brain ventricle is the outer boundary of the brain ventricle. In a three-dimensional image, the edge takes the form of a surface. In a two-dimensional, cross sectional, image, the edge of the brain ventricle is a curve.

A length measurer 53 may be provided for establishing a length measure of a path through the ventricle, the path terminating at the edge point and comprising a central point of the brain ventricle. Such a length measure can play an important role in diagnosing brain diseases. However, a straight line may be used as the path; in such a case, the path may not be completely contained in the brain ventricle.

The path may further terminate at the central point. In this case, one end of the path terminates at the central point, and the other end of the path terminates at the edge point. The path is for example a straight line. A straight line is efficient to compute and provides good results. However, it is also possible that the path is a curve which follows the shape of the ventricle. This provides a higher accuracy of the results.

The edge detector 52 may be arranged for detecting an edge point at an end of a lobe of the brain ventricle. In this case, the length measure corresponds to an extent of the lobe. The end of the lobe, or corner point of the ventricle, may be found by finding the longest line from the center point to any of a plurality of edge points of the lobe.

The brain ventricle of the human brain comprises a lateral ventricle. The lateral ventricle thus is a known anatomical structure. In a 2D axial slice of the brain, the lateral ventricle may be represented as having a plurality of lobes extending from a central portion. The edge detector may be arranged for identifying an edge point on the far end of the posterior right lobe of the lateral ventricle. The distance from the central point to this edge point has a particular relevance.

The edge detector 52 may be arranged for selecting two edge points of the brain ventricle which are connected to each other by a line intersecting the center point, such that a distance between the two edge points is substantially minimal, the length measurer being arranged for establishing the substantially minimal distance. This measure corresponds to the width of the third ventricle. In an embodiment, the central point may be identified as the point halfway the two selected edge points.

The edge detector 52 may be arranged for identifying a plurality of edge points on the edge of the brain ventricle, and the length measurer 53 may be arranged for establishing the length from the central point to each of the plurality of edge points, to obtain a plurality of lengths. This plurality of lengths may be shown on a display as a graph, as shown in FIG. 3. This graph may also be printed or stored in a patient record. The plurality of lengths may also be forwarded to a statistics module 62 which may be provided for computing a statistical quantity of the plurality of lengths, such as the mean or median.

A central point detector 51 may be provided for identifying the central point of the brain ventricle. This central point may be a point of gravity, for example, or a mean of the coordinates of the image elements (such as voxels, pixels) of the brain ventricle. Or, the central point can be the middle of a bounding box of the brain ventricle, wherein the bounding box is chosen to be just large enough to contain the ventricle. Alternatively, with reference to FIG. 2A, the center point may be the intersection point 4 of two cross sectional lines 3 and 13 of the brain ventricle, each cross sectional line connecting two opposite corner points of the brain ventricle. Alternatively, the central point may also be detected as the middle of the line 9.

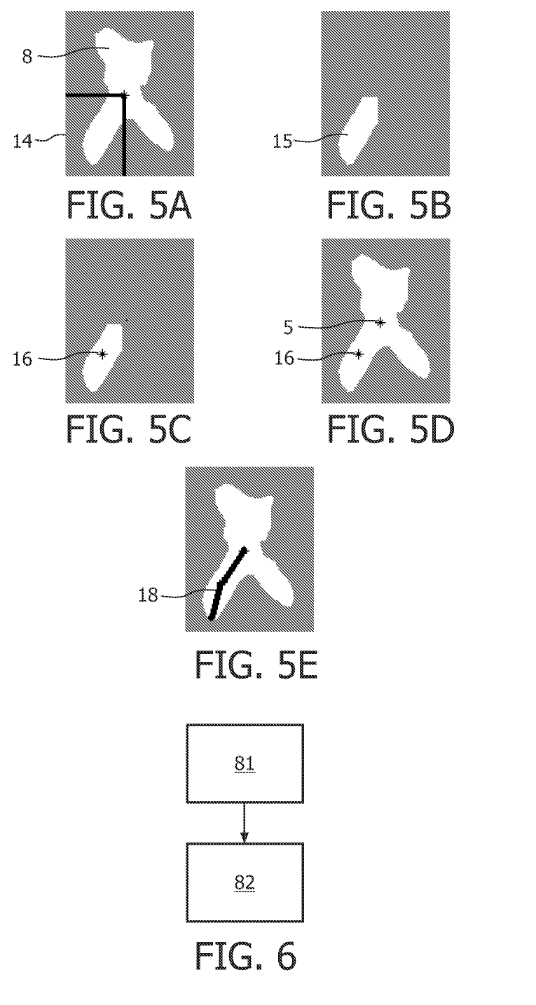

Means 54 may be provided for identifying a region 14 of the image. A boundary of the region 14 is determined based on the first central point 5. For example, the boundary of the region 14 comprises the first central point, or comes close to the first central point 5. The region 14 is selected such that it comprises a portion of the image having a predetermined orientation with respect to the first central point 5, for example the region extends from the first central point 5 to the bottom left of the image, as is the case in FIG. 5A, or from the first central point 5 to the top right of the image (not shown). For example, a quadrant of the image is chosen using the central point as the origin. An example of this is illustrated in FIG. 5A-E. In this Figure, the bottom left quadrant of the image is selected as the region 14. The means 54 may be applied to each one of the four quadrants surrounding the central point. Means 50 may be provided for identifying a second part 15 of the brain ventricle comprising an intersection of the first part 8 of the brain ventricle with the region 14. The center point detector 51 may be arranged for identifying a second central point 16 of the second part 15 of the brain ventricle. Then, there are two central points, as illustrated in FIG. 5D. This process may be repeated, for example the bottom left quadrant may be established with respect to the second central point, and a third central point may be computed of the intersection of the ventricle with this latter quadrant. After a few iterations, a point representing the edge point 17 at the end of a lobe is found as the central point. Such a way of finding the end of the lobe is relatively robust to noise or other inaccuracies in the image data. The distance from the first central point 5 to the edge point 17 may be computed as a distance along a straight line 10 or as a distance along the path 18 passing the computed central points including the second central point 16.

It will be understood that the system can be applied to a two-dimensional image or to a three-dimensional image. If a three-dimensional image is used, a possible approach is to compute the distances in one or more cross sectional slices or multi-planar reformatted slices (MPR). In the case of a cross sectional slice (or a plurality of parallel MPRs), it is possible to compute the (first) central point 5, based on a plurality of slices, for example by averaging the central points identified in each individual image. This makes the determination of the central point more reliable. The same (averaged) central point can be used to perform the distance measurement in each of the plurality of images. This way, more information is made available to support the diagnosis.

The distances found may be the input of a decision support system or computer-aided detection system for classifying the medical image, based on the length measure. Such systems are known in the art. Based on the present description, the skilled person can adapt such systems to enable them to process the distance values produced by the system set forth.

The system set forth may be comprised in a medical workstation comprising an output 58 for generating a visualization of the distances measured, as for example shown in FIGS. 2C, 2D, and 5E. Also, a numerical value representing the distance(s) measured may be visualized. The output 58 may comprise a display, a printer, or a network output for storing the information on a server in an electronic patient file.

The system set forth may also be comprised in a medical imaging apparatus for acquiring a medical image, for example an MR imaging apparatus, a CT imaging apparatus, or an ultrasound device. Such an imaging apparatus has a scanner 57 for generating the medical image and providing the medical image to the input 61.

FIG. 6 illustrates a method of analyzing a brain ventricle represented in a medical image dataset. The method comprises a step 81 of identifying an edge point on an edge of the brain ventricle; and a step 82 of establishing a length measure of a path through the ventricle, the path terminating at the edge point and comprising a central point of the brain ventricle. This method can be implemented in software on a computer workstation, for example.

The shape descriptors set forth have been compared with the area (and volume) in a classification task of Alzheimer's disease patients and healthy controls. The analysis showed that areas of the ventricle in a cross sectional brain image in the two groups are significantly different at p=0.066. The mean value of the perimeter of the ventricle was found to be significantly different at p=0.055. The posterior right “wing length” 10 was significantly different at p=0.032, making it a more reliable descriptor. The posterior left “wing length” 11 was significantly different at p=0.066. The “width/thickness” was significantly different at p=0.030, and the “mean signature value” was significantly different at p=0.028.

The described algorithms and measurement values may be used in an MR advanced image analysis toolkit. Moreover, the descriptors can be used in decision support systems (DSS) and computer-aided detection (CAD) systems. Also, the values may be interpreted manually by the experts. The ventricle-based descriptors have applications to dementia diagnosis, such as Alzheimer's disease, and other diseases that show ventricle enlargement, such as hydrocephalus and schizophrenia.

It will be appreciated that the invention also extends to computer programs, particularly computer programs on or in a carrier, adapted for putting the invention into practice. The program may be in the form of source code, object code, a code intermediate source and object code such as a partially compiled form, or in any other form suitable for use in the implementation of the method according to the invention. It will also be appreciated that such a program may have many different architectural designs. For example, a program code implementing the functionality of the method or system according to the invention may be subdivided into one or more subroutines. Many different ways to distribute the functionality among these subroutines will be apparent to the skilled person. The subroutines may be stored together in one executable file to form a self-contained program. Such an executable file may comprise computer-executable instructions, for example processor instructions and/or interpreter instructions (e.g. Java interpreter instructions). Alternatively, one or more or all of the subroutines may be stored in at least one external library file and linked with a main program either statically or dynamically, e.g. at run-time. The main program contains at least one call to at least one of the subroutines. Also, the subroutines may comprise function calls to each other. An embodiment relating to a computer program product comprises computer-executable instructions corresponding to each of the processing steps of at least one of the methods set forth. These instructions may be subdivided into subroutines and/or be stored in one or more files that may be linked statically or dynamically. Another embodiment relating to a computer program product comprises computer-executable instructions corresponding to each of the means of at least one of the systems and/or products set forth. These instructions may be subdivided into subroutines and/or be stored in one or more files that may be linked statically or dynamically.

The carrier of a computer program may be any entity or device capable of carrying the program. For example, the carrier may include a storage medium, such as a ROM, for example a CD ROM or a semiconductor ROM, or a magnetic recording medium, for example a floppy disc or hard disk. Further, the carrier may be a transmissible carrier such as an electrical or optical signal, which may be conveyed via electrical or optical cable or by radio or other means. When the program is embodied in such a signal, the carrier may be constituted by such a cable or other device or means. Alternatively, the carrier may be an integrated circuit in which the program is embedded, the integrated circuit being adapted for performing, or for use in the performance of, the relevant method.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. Use of the verb “comprise” and its conjugations does not exclude the presence of elements or steps other than those stated in a claim. The article “a” or “an” preceding an element does not exclude the presence of a plurality of such elements. The invention may be implemented by means of hardware comprising several distinct elements, and by means of a suitably programmed computer. In the device claim enumerating several means, several of these means may be embodied by one and the same item of hardware. The mere fact that certain measures are recited in mutually different dependent claims does not indicate that a combination of these measures cannot be used to advantage.

1. A system for analyzing a brain ventricle (8) represented in a medical image dataset, comprising
an edge detector (52) for identifying an edge point (17) on an edge of the brain ventricle; and
a length measurer (53) for establishing a length measure of a path (10) comprising a central point (5) of the brain ventricle and terminating at the edge point (17).

2. The system of claim 1, the path starting at the central point.

3. The system of claim 1, the edge detector (52) being arranged for detecting an edge point at an end of a lobe of the brain ventricle, the length measure corresponding to an extent of the lobe.

4. The system of claim 3, the brain ventricle comprising a lateral ventricle and the lobe comprising a posterior right lobe of the lateral ventricle.

5. The system of claim 1, the edge detector (52) being arranged for selecting two edge points of the brain ventricle which are connected by a line (9) intersecting the center point (5), such that a distance between the two edge points is substantially minimal, the length measurer being arranged for establishing the substantially minimal distance.

6. The system according to claim 2, the edge detector (52) being arranged for identifying a plurality of edge points (7) on the edge of the brain ventricle; and
the length measurer (53) being arranged for establishing the length from the central point (5) to each of the plurality of edge points (7), to obtain a plurality of lengths.

7. The system according to claim 6, further comprising a statistics module (62) for computing a statistical quantity of the plurality of lengths.

8. The system of claim 2, further comprising
a central point detector (51) for identifying a first central point (5) of a first part (8) of the brain ventricle;
means for identifying a region (14) of the image, a boundary of the region (14) being based on the first central point (5); and
means for identifying a second part (15) of the brain ventricle comprising an intersection of the first part (8) of the brain ventricle with the region (14);
the center point detector (51) further being arranged for identifying a second central point (16) of the second part (15) of the brain ventricle.

9. The system of claim 8, the length measurer (53) being arranged for establishing the length measure as a length of a path (18) from the first central point (5) to the edge point (17) via the second central point (16).

10. The system of claim 1, the medical image comprising a 2D cross section of a 3D medical image dataset.

11. The system of claim 1, further comprising a decision support system (55) for classifying the medical image, based on the length measure.

12. A medical workstation comprising the system according to claim 1 and an output (58) for generating a human-readable representation of the length measure and a graphical indication of the path in the medical image.

13. A medical imaging apparatus for acquiring a medical image, the medical imaging apparatus comprising the system according to claim 1 and a scanner (57) for generating the medical image.

14. A method of analyzing a brain ventricle represented in a medical image dataset, comprising
identifying (81) an edge point on an edge of the brain ventricle; and
establishing (82) a length measure of a path through the ventricle, the path terminating at the edge point and comprising a central point of the brain ventricle.

15. A computer program product comprising computer instructions for causing a processor system to perform the method according to claim 14.
